(19) United States
(12) Patent Application Publication
(10) Pub. No.: US 2026/0164297 A1
(43) Pub. Date: Jun. 11, 2026

(54) TECHNOLOGIES FOR LOGICAL CHANNEL GROUP SPECIFIC BUFFER STATUS REPORTING

(71) Applicant: Apple Inc., Cupertino, CA (US)

(72) Inventors: Ping-Heng Kuo, London (GB); Fangli Xu, Beijing (CN); Ralf Rossbach, Munich (DE)

(73) Assignee: Apple Inc., Cupertino, CA (US)

(21) Appl. No.: 18/708,566

(22) PCT Filed: May 11, 2023
(86) PCT No.: PCT/CN2023/093425

§ 371 Date: May 8, 2024

(51) Int. Cl. H04W 28/02

(52) U.S. Cl. CPC H04W 28/0278

(57) ABSTRACT

The present application relates to devices and components including apparatus, systems, and methods for buffer status reporting in wireless networks.

### TECHNICAL FIELD

This application relates generally to communication networks and, in particular, to technologies for logical channel group buffer status reporting in such networks.

### BACKGROUND

Buffer status reports are important mechanisms for a user equipment (UE) to inform a base station on an amount of uplink data that has arrived in a buffer of the UE. The base station may use this information to allocate uplink resources to accommodate the buffered data.

### BRIEF DESCRIPTION OF THE DRAWINGS

FIG. 1 illustrates a network environment in accordance with some embodiments.

FIG. 2 illustrates a mapping in accordance with some embodiments.

FIG. 3 illustrates another mapping in accordance with some embodiments.

FIG. 4 illustrates another mapping in accordance with some embodiments.

FIG. 5 illustrates another mapping in accordance with some embodiments.

FIG. 6 illustrates another mapping in accordance with some embodiments.

FIG. 7 illustrates an operational flow/algorithmic structure in accordance with some embodiments.

FIG. 8 illustrates another operational flow/algorithmic structure in accordance with some embodiments.

FIG. 9 illustrates another operational flow/algorithmic structure in accordance with some embodiments.

FIG. 10 illustrates an user equipment in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

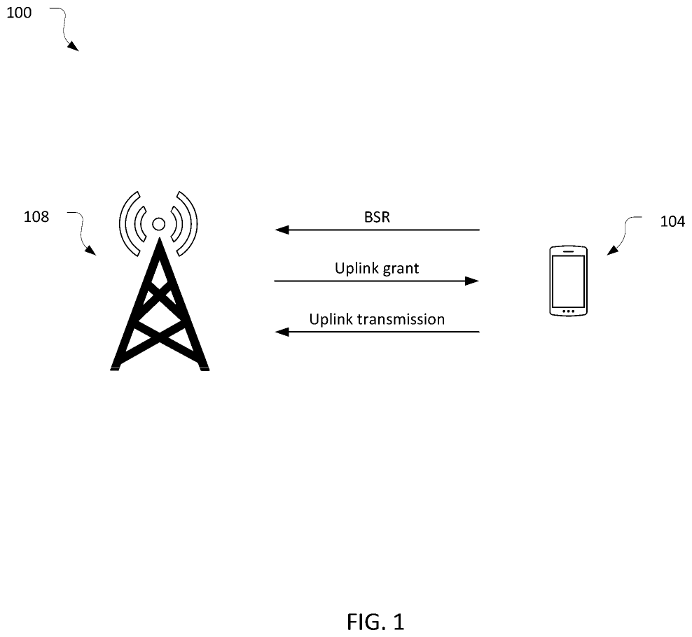

FIG. 1 illustrates a network environment 100 in accordance with some embodiments. The network environment 100 may include a UE 104 coupled with a base station (BS) 108 of a radio access network (RAN). In some embodiments, the base station 108 is a next-generation node B (gNB) that provides one or more 3GPP New Radio (NR) cells. In other embodiments, the base station 108 is an evolved node B (eNB) that provides one or more Long Term Evolution (LTE) cells. The air interface over which the UE 104 and base station 108 communicate may be compatible with 3GPP technical specifications, such as those that define Fifth Generation (5G) NR or later system standards.

The UE 104 may send a buffer status report (BSR) to the base station 108 to indicate an amount of uplink data that the UE 104 has to transmit. The BSR may be transmitted as a media access control (MAC) control element (CE) on a physical uplink shared channel (PUSCH). The BSR may be associated with a logical channel group (LCG) having one or more logical channels (LCHs). Upon receiving the BSR, the base station 108 may determine an appropriate amount of uplink resources for the UE 104. The base station 108 may then transmit an uplink grant to the UE 104. The UE 104 may use the UL grant for a subsequent uplink transmission.

Traffic types are evolving to accommodate new use cases in developing cellular networks. For example, efforts are being undertaken to improve RAN operation to support traffic having characteristics associated with extended reality (XR) traffic to provide, for example, high throughput, low-latency, and high reliability. Various enhancements to BSR operation may be used to improve capacity for XR use cases. While some embodiments are described with reference to XR traffic, other embodiments may apply similar concepts to other types of traffic.

BSR tables having a finer granularity than existing tables may be used to enhance BSR for XR use cases. Existing BSR tables in 3GPP TS 38.321 v17.4.0 (2023-03-29) have a quantization error of the buffer size levels that increases for higher buffer size levels. As packet sizes for XR traffic may be quite large (for example, with reference to a video frame), the quantization error may lead to a degradation of resource efficiency. Thus, BSR enhancements that aim to reduce the quantization error of the reported buffer size may allow the base station 108 to allocate uplink resources in a more appropriate manner.

The BSRs may be further enhanced for XR use cases by including additional types of information. Existing BSRs only provide information about a buffer size. In order to facilitate delay-aware scheduling for XR (or other) traffic that has latency constraints, the BSR may further include information relating to delay status of the buffered data. For example, the BSR may include an indication of how long the data has been queued or an amount of time that remains until a delivery deadline. Providing the buffer delay information with the BSR may allow the base station 108 to know how long the buffered data for an LCH/LCG has been waiting or how urgent it is to transmit the buffered data before a corresponding delivery deadline.

BSR enhancements may be facilitated by additional BSR formats and tables developed to accommodate provision of information related to finer granularity buffer sizes and delay information.

In some instances, the network (e.g., the base station 108) may provide LCH/LCG-specific configuration information with respect to BSRs. For example, the base station 108 may configure the UE 104 with an indication of which BSR table(s) are to be used by an LCH/LCG. For another example, the base station 108 may configure specific LCHs/LCGs for which delay information is to be reported. This may reflect a situation in which a subset of the LCHs/LCGs do not need, or otherwise benefit from, reporting of delay information. For example, only LCHs/LCGs that map to QoS flows with shorter delay budget may need delay reporting. Thus, the base station 108 may configure those LCHs/LCGs for delay information reporting, while other LCHs/LCGs are not configured for delay information reporting. In yet another example, the BSR triggering events may be LCH/LCG specific. For example, a BSR with delay information for an LCH/LCG may be triggered when a remaining time until the delivery deadline drops below a predetermined threshold.

To accommodate the LCH/LCG-specific configurations, BSR formats may be defined per LCH/LCG. For example, given that BSRs with respect to some LCHs/LCGs may not include delay information, a BSR MAC CE format used for such a report may be defined without a field for delay information.

Thus, BSR enhancements may correspond to LCH/LCG-specific buffer size tables, BSR formats, BSR triggering events, etc. The existing BSR framework as defined by, for example, 3GPP TS 38.321, will not accommodate such BSR enhancements. This may be due to the existing BSR framework having the buffer size table, BSR format, and BSR triggering events all fixed by 3GPP TS 38.321 and applied across all LCGs in a MAC entity. Presently, the only configurable BSR-related parameters are a periodic BSR timer, a retransmission BSR timer, and the logical channel scheduling request delay timer. These BSR-related parameters are configured within a BSR configuration. A BSR configuration is provided by a BSR-Config information element (IE) in a MAC-cell group configuration (MAC-CellGroupConfig). Thus, in existing networks, the BSR configuration (and the configurable BSR-related parameters mentioned above) are MAC specific as opposed to LCH/LCG specific.

Embodiments of the present disclosure provide flexible BSR and LCH/LCG configuration framework that can specify BSR-related behavior applicable to a particular LCH/LCG, as opposed to having a common set of BSR-related behaviors across all LCHs/LCGs in a MAC entity. A first aspect of the disclosure provides a plurality of BSR configurations per MAC entity. A second aspect of the disclosure provides ways in which a single BSR configuration per MAC entity may be used while still providing LCH/LCG-specific BSR-related parameters.

To provide the first aspect of the disclosure related to configuring a MAC entity with a plurality of BSR configurations, an LCH/LCG of a MAC entity may be associated with a plurality of BSR configurations. The association of the LCH/LCG with the BSR configurations may be preconfigured in, for example, the LCH/LCG configuration.

Each BSR configuration may include both conventional BSR configuration parameters and one or more additional BSR configuration parameters. The conventional BSR configuration parameters may include a periodic BSR timer, a retransmission BSR timer, and a logical channel scheduling request (SR) delay timer. The additional BSR configuration parameters may include, but are not limited to: a BSR configuration identifier (ID), buffer size table ID(s), delay value table ID(s), BSR format(s), BSR triggering event(s), BSR cancellation event(s), or a BSR MAC CE priority.

The BSR configuration ID may provide an identification of the BSR configuration in the MAC entity. This may allow the UE 104 to uniquely identify a BSR configuration from a plurality of BSR configurations of the MAC entity.

The buffer size table ID(s) may provide an identification of one or more buffer size (BS) tables that may be used for BS reporting of an LCH/LCG associated with a corresponding BSR configuration. For example, the BS table may be: a legacy BS table as defined in, for example, 3GPP TS 38.321 or a newly introduced BS table with finer granularity as compared to the legacy BS tables. In some embodiments, a BS table may be indicated generically or by reference to table parameters (for example, a BS table with a given highest buffer size, a given lowest buffer size, or a given step size).

The delay value table ID(s) may provide an identification of one or more delay value table(s) that may be used for delay information reporting of an LCH/LCG associated with a corresponding BSR configuration. In some embodiments, the delay information conveyed by a delay value table may provide a remaining time until a delivery deadline associated with buffered data of the LCH/LCG. This allows the UE 104 to inform the base station 108 of the amount of time the UE 104 has to transmit the data of the LCH/LCG.

The BSR format(s) may provide an identification of BSR MAC CE format(s) that are allowed to be used for buffer status reporting for the LCH/LCG associated with the corresponding BSR configuration. For example, the allowed BSR MAC CE format may provide relevant fields for reporting the information to be included in the BSR (for example, buffer size or delay information). The BSR format(s) may include, but are not limited to: a BSR format corresponding to normal granularity of buffer size per LCH/LCG (e.g. based on legacy buffer size table); a BSR format corresponding to a finer granularity of buffer size per LCH/LCG (for example, two buffer size values per LCH/LCG, a buffer size corresponding to BS Tables with more codepoints, or a buffer size corresponding to BS Tables with smaller step sizes or narrower range); a BSR format without any field for delay information reporting; a BSR format with explicit field(s) for delay information reporting of one or more LCHs/LCGs; a BSR format with explicit field(s) for indication of BS Table(s) used for one or more LCHs/LCGs; or any legacy BSR format defined in existing 3GPP specifications such as, for example, 3GPP TS 38.321.

The BSR triggering event(s) may provide an identification of events that can trigger buffer status reporting for the LCH/LCG associated with the corresponding BSR configuration. The events may be based on, for example, packet discarding, buffer size or delay information that may or may not be related the LCH/LCG associated with the corresponding BSR configuration. In some embodiments, parameters relating to the BSR triggering events may also be included in the BSR configuration or associated therewith. For example, a threshold corresponding to the trigger event may be provided. In one example, the threshold may correspond to a buffer size. If the amount of buffered data reaches or exceeds the threshold, the UE 104 may determine that the trigger event has occurred. In another example, the threshold may correspond to an amount of remaining time to a delivery deadline. If the buffered data has a remaining time to the delivery deadline less than the threshold, the UE 104 may determine that the trigger event has occurred.

The BSR cancellation event(s) may provide an identification of events that can cancel triggered buffer status reporting for the LCH/LCG associated with the corresponding BSR configuration. The events may be based on, for example, buffer size or delay information. In some embodiments, parameters relating to the BSR cancellation events may also be included in the BSR configuration or associated therewith. For example, a threshold corresponding to the trigger event may be provided. In one example, the threshold may correspond to a buffer size. If the amount of buffered data drops to or becomes less than the threshold, the UE 104 may determine that the cancellation event has occurred and cancel a BSR that was previously triggered but not yet sent. In some embodiments, the amount of buffered data may drop due to packet discarding of the type associated with XR traffic.

Various events that may serve as basis for BSR triggering (or cancellation) events include, but are not limited to: data becoming available in an LCH/LCG associated with corresponding BSR configuration; volume of buffered data in an LCH/LCG associated with corresponding BSR configuration satisfying a threshold (for example, equal to, greater than, or less than a corresponding threshold); a remaining time until a delivery deadline of the buffered data in the LCH/LCG associated with corresponding BSR configuration satisfying a threshold (for example, equal to, greater than, or less than a corresponding threshold); packet discarding occurring in the LCH/LCG associated with corresponding BSR configuration; or volume of discarded data in the LCH/LCG associated with corresponding BSR configuration satisfying a threshold (for example, equal to, greater than, or less than a corresponding threshold).

The BSR MAC CE priority may provide an indication of a priority of a BSR MAC CE generated based on the corresponding BSR configuration. The priority may be used in cases in which more than one BSR configuration have triggered/generated BSRs as will be described in further detail herein.

Having a plurality of BSR configurations per MAC entity may be enabled by associating each LCH/LCG with a BSR configuration based on a pre-configuration or other basis. For example, each LCH/LCG configuration may include a BSR-Config ID. The UE 104 may use the BSR-Config ID to map the LCH/LCG to an associated BSR configuration.

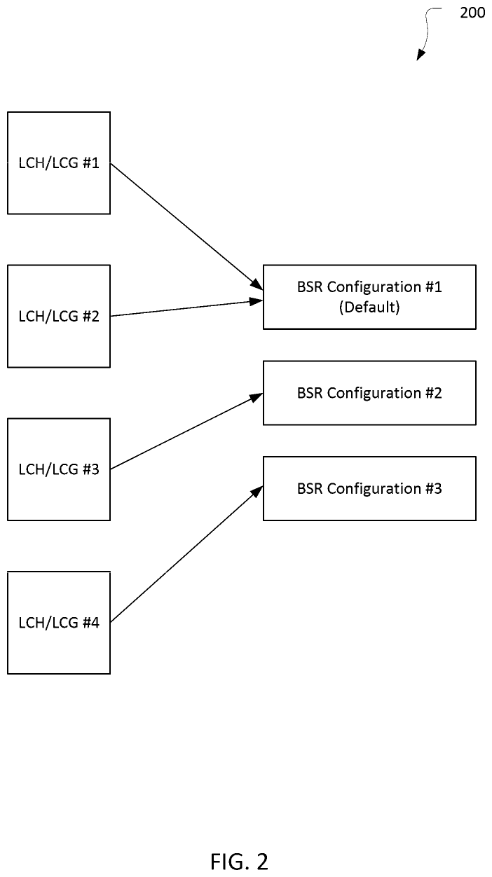

FIG. 2 illustrates an example of a mapping 200 in accordance with some embodiments. The mapping 200 may associate LCHs/LCGs #1-#4 with BSR configurations #1-#3. As shown, LCHs/LCGs #1 and #2 may be mapped to BSR configuration #1; LCH/LCG #3 may be mapped to BSR configuration #2, and LCH/LCG #3 may be mapped to BSR configuration #2. It will be understood that different embodiments may include different numbers of LCHs/LCGs and BSR configurations and different mappings.

The UE 104 may perform BSR-related actions with respect to buffered data of an LCH/LCG based on the parameters defined in a BSR configuration associated with the LCH/LCG. For example, the UE 104 may monitor buffered data of LCH/LCG #1 and determine whether a triggering event, defined in associated BSR configuration #1, is detected. If the triggering event is detected, the UE 104 may trigger a BSR for the LCH/LCG #1. The BSR may be generated/transmitted based on BSR-related parameters of BSR configuration #1.

In this manner, BSR-related parameters (for example, a triggering event (as well as the related parameters, if any), a cancellation event (as well as the related parameters, if any), etc.) may be configurable and may be different across different BSR configurations.

In some embodiments, restrictions may be imposed on reporting buffer status information (including buffer size and buffer delay information) of different LCHs/LCGs with respect to associated BSR configurations. For example, in some embodiments, only the buffer status information of LCHs/LCGs associated with the same BSR configuration may be allowed to be reported together in one MAC CE. So, with reference to FIG. 2, a MAC CE may be allowed to have a BSR for both LCH/LCG #1 and LCH/LCG #2, but would not be able to have a BSR for both LCH/LCG #3 and LCH/LCG #4.

As shown in FIG. 2, BSR configuration #1 may be considered a default BSR configuration. If an LCH/LCG is not associated with any BSR configuration, for example, its LCH/LCG configuration does not include a BSR-Config ID, then it may be assumed to be associated with the default BSR configuration. The default BSR configuration may also be used to supplement information in other BSR configurations. For example, if a BSR-related parameter is absent from a BSR configuration, then the same BSR-related parameter value as the default BSR configuration may be applied in this BSR configuration.

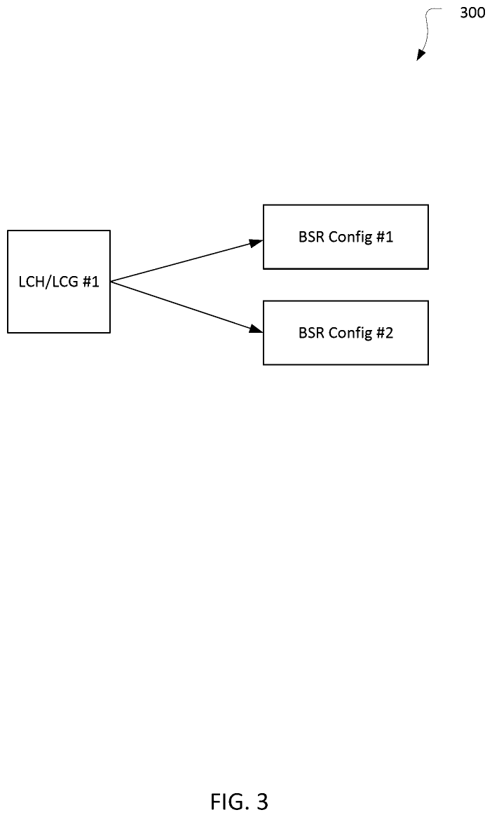

While the mapping 200 illustrates any one LCH/LCG being associated with no more than one BSR configuration, other embodiments may include an LCG/LCH associated with a plurality of BSR configurations. FIG. 3 illustrates an example of a mapping 300 in which LCH/LCG #1 is associated with both BSR configurations #1 and #2. In this embodiment, the UE 104 may select BSR-related parameters from either of the associated BSR configurations for BSR-related actions. For example, the buffer size of the LCH/LCG #1 may be reported based on either a BS table indicated in BSR configuration #1 or BSR configuration #2. For another example, a BSR for LCH/LCG #1 may be triggered by events indicated in either BSR configuration #1 or BSR configuration #2. The UE 104 may have some flexibility in determining whether to use a BSR-related parameter from BSR configuration #1 or BSR configuration #2. In some embodiments, the UE 104 may have selection criteria that is relied upon to select an appropriate parameter. The selection criteria may be predefined by a 3GPP TS or configured by, for example, the base station 108.

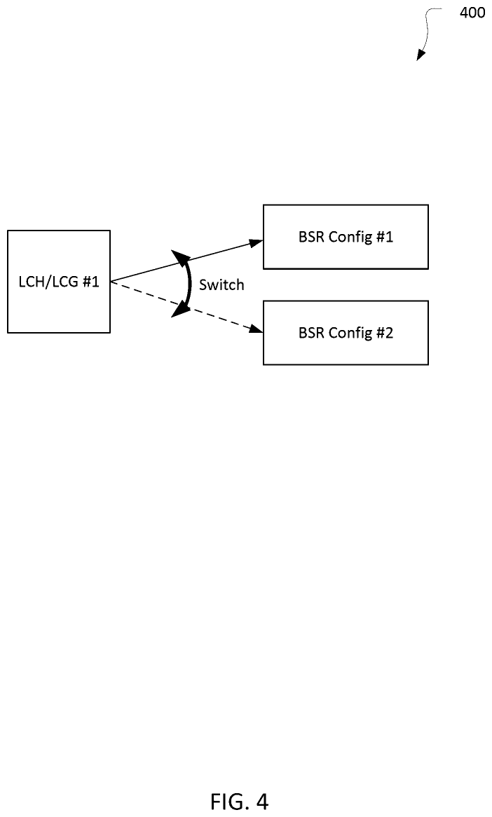

In some embodiments, the association of an LCH/LCG to a BSR configuration may be statically configured. In other embodiments, the association of an LCH/LCG to a BSR configuration may be dynamically updated. For example, in some embodiments an LCH/LCG may be switched between a plurality of BSR configurations. FIG. 4 illustrates an example of a mapping 400 in which LCH/LCG #1 is first associated with BSR configuration #2 and, subsequently, is switched to being associated with BSR configuration #1. The UE 104 may switch between the different BSR configurations. For example, in some embodiments, the UE 104 may be configured to use BSR configuration #1 for a BSR if the buffer size of the LCH/LCG is smaller than a threshold. If the buffer size of the LCH/LCG is not smaller than the threshold, the UE 104 may generate a BSR for the LCH/LCG based on BSR configuration #2. The conditions for BSR configuration switching (for example, threshold level of buffer size) can be predefined by a 3GPP TS or configured by, for example, the base station 108. The switching conditions may be defined/configured per LCH/LCG. In some embodiments, the UE 104 may be configured to switch BSR configuration associated to a LCH/LCG upon reception of an instruction signal from the base station, such a MAC CE, a DCI, or a RRC reconfiguration message.

According to TS 38.321, currently a MAC protocol data unit (PDU) can only have up to one BSR MAC CE. “A MAC PDU shall contain at most one BSR MAC CE, even when multiple events have triggered a BSR.” 3GPP TS 38.321, page 70. In embodiments in which a plurality of BSR configurations per MAC entity are supported, two or more BSR configurations may trigger BSRs for different LCHs/LCGs. In order to comply with the above constraint of TS 38.321, the UE 104 may determine which BSR MAC CE to include in the MAC PDU based on one or more of the following options.

In a first option, the UE 104 may select the BSR MAC CE from the BSR configuration with a higher priority. For example, if the plurality of BSR configurations each include a priority level parameter, the UE 104 may select the BSR MAC CE from the BSR configuration having the relatively highest priority level.

In a second option, the UE 104 may select a BSR MAC CE from a BSR configuration having a higher/lower BSR configuration ID.

In a third option, the UE 104 may select a BSR MAC CE from a BSR configuration associated with an LCH/LCG with a relatively higher priority. For example, each LCH/LCG may have a priority level. The UE 104 may determine which LCH/LCG has the higher priority level and select the BSR MAC CE for the buffered data of that LCH/LCG for inclusion into the BSR MAC CE.

In a fourth option, the UE 104 may select a BSR MAC CE from a BSR configuration that has a BSR format comprising delay reporting field. Consider, for example, that BSR MAC CEs are triggered for both a first BSR configuration, which has a BSR format without a delay reporting field, and a second BSR configuration, which has a BSR format with a delay reporting field. Given that the delay reporting field is typically associated with more latency-sensitive data, the UE 104 may give priority to the BSR MAC CE for the second BSR configuration for inclusion in the MAC PDU.

In some embodiments, more than one BSR MAC CE may be included in a MAC PDU. This may include modification of the above-noted constraint of 3GPP TS 38.321. These embodiments may use one or more of the following options.

In a first option, two or more BSR MAC CEs may be multiplexed into the same MAC PDU when one or more conditions are met. For example, two or more BSR MAC CEs may be multiplexed into the same MAC PDU when one of the BSR MAC CEs is triggered by specific BSR configuration(s). For another example, two or more BSR MAC CEs may be multiplexed into the same MAC PDU when more than one (for example, all) of the BSR MAC CEs are triggered by specific BSR configuration(s). For yet another example, two or more BSR MAC CEs may be multiplexed into the same MAC PDU when the BSR MAC CEs are triggered by different BSR configurations.

In a second option, two or more BSR MAC CEs may be multiplexed into the same MAC PDU without constraint. For example, the UE 104 may be always allowed to multiplex two or more BSR MAC CEs into the same MAC PDU.

As introduced above, the second aspect of the disclosure relates to providing a single BSR configuration per MAC entity that may be used while still providing LCH/LCG-specific BSR-related parameters. In some embodiments of the second aspect, a MAC entity may be configured with a single BSR configuration that includes various sets of parameters. For example, the BSR configuration may include a plurality of values for individual BSR-related parameters. The BSR-related parameters may include conventional BSR configuration parameters and additional BSR configuration parameters. Similar to that described above with respect to the first aspect, the conventional BSR configuration parameters may include a periodic BSR timer, a retransmission BSR timer, and a logical channel scheduling request (SR) delay timer, and the additional BSR configuration parameters may include, but are not limited to: a BSR configuration identifier (ID), buffer size table ID(s), delay value table ID(s), BSR format(s), BSR triggering event(s), BSR cancellation event(s), or a BSR MAC CE priority. Each LCH/LCG may be associated with selected value set(s) of the available value sets for a given BSR-related parameter.

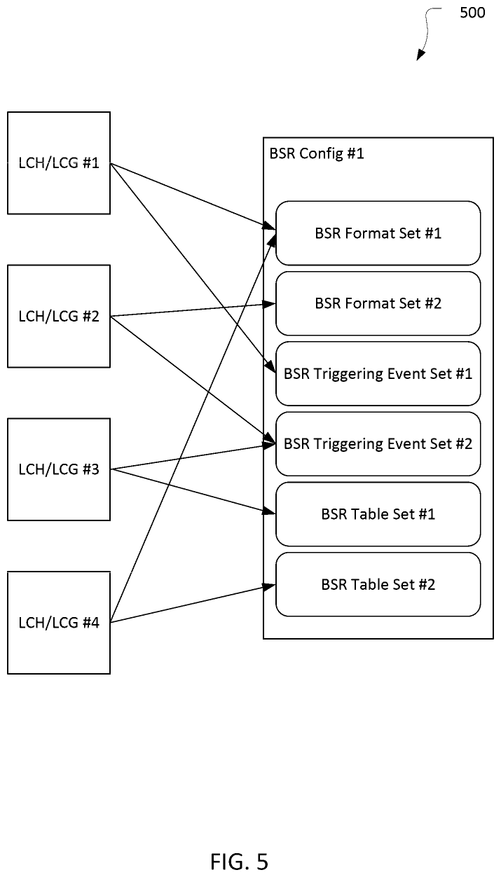

FIG. 5 illustrates a mapping 500 in accordance with some embodiments. The mapping 500 may associate LCHs/LCGs #1-#4 with various sets of BRS-related parameters within BSR configuration #1. As shown, the BSR configuration #1 may include three BSR-related parameters: BSR formats, BSR triggering events, and BSR tables. Each of the BSR-related parameters may include two sets of values. Each set may include one or more values of a corresponding BSR-related parameter. For example, BSR format set #1 may include one or more BSR formats, BSR triggering event set #1 may include one or more BSR triggering events, and BSR table set #1 may include one or more BSR tables. It will be understood that other embodiments may include other BSR-related parameters and other numbers of sets for individual BSR-related parameters.

As shown in the mapping 500, LCH/LCG #1 is associated with BSR format set #1 and BSR triggering event set #1, LCH/LCG #2 is associated with BSR format set #2 and BSR triggering event set #2, LCH/LCG #3 is associated with BSR triggering event set #2 and BSR table set #1, and LCH/LCG #4 is associated with BSR format set #1 and BSR table set #1.

Each of the sets of BSR-related parameters within the BSR configuration may be provided a parameter set ID. The mappings of the LCHs/LCGs to the various sets of BSR-related parameters may then be based on the parameter set ID provided in the corresponding LCH/LCG configuration.

In some embodiments, the BSR configuration may include default values for various BSR-related parameters. If an LCH/LCG is not explicitly associated with a defined set of the BSR configuration (for example, the LCH/LCG configuration does not include a parameter set ID for a particular BSR-related parameter), the LCH/LCG may be determined to be associated with a default value of the BSR-related parameter.

In another embodiment of the second aspect, the MAC entity is configured with a single BSR configuration having some BSR-related parameters while individual LCH/LCG configurations are provided with other BSR-related parameters. For example, the single BSR configuration may include conventional BSR configuration parameters such as the periodic BSR timer, the retransmission BSR timer, and the logical channel SR delay timer. The individual LCHs/LCGs may then be configured with additional parameters such as those described above with respect to the first aspect. The additional parameters may include, but are not limited to: buffer size table ID(s), delay value table ID(s), BSR format(s), BSR triggering event(s), BSR cancellation event(s), or a BSR MAC CE priority.

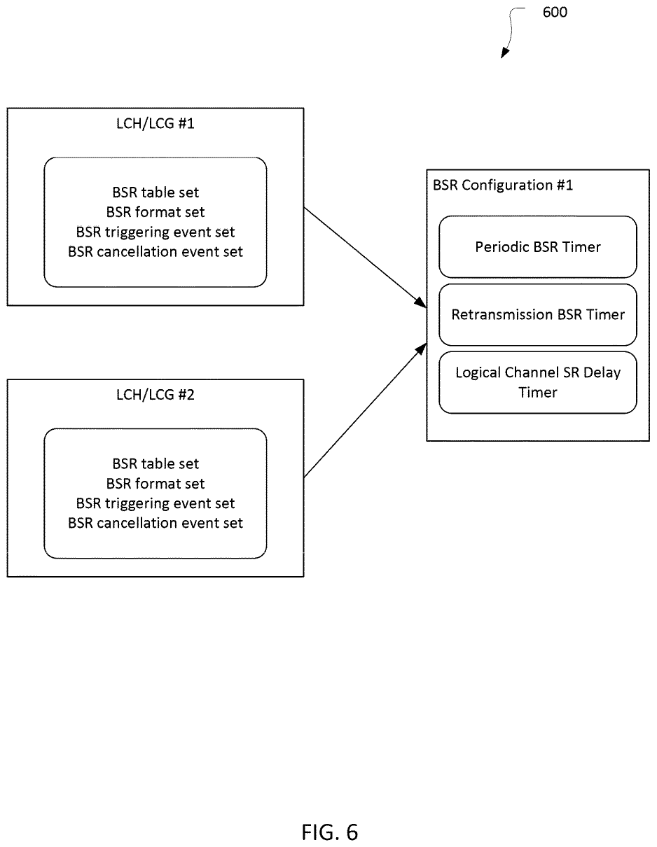

FIG. 6 illustrates a mapping 600 in accordance with some embodiments. The mapping 600 may associate LCHs/LCGs #1 and #2 with BSR configuration #1. As shown, the BSR configuration #1 may include the conventional BSR-related parameters: periodic BSR timer, retransmission. Each of LCH/LCG #1 and LCH/LCG #2 may be configured with a respective combination of additional BSR-related parameters. The additional BSR-related parameters shown in FIG. 6 include a BSR table set, a BSR format set, a BSR triggering event set, and a BSR cancellation event set. In other embodiments, additional/alternative parameters may provided in the different LCH/LCG configurations.

In some embodiments, the BSR configuration may be provided with default parameters that may be used in the event that the LCH/LCG configurations do not include a particular BSR-related parameter. For example, a BSR configuration may be provided with a BSR table set. If an LCH/LCG configuration includes a BSR table set, the BSR table set of the LCH/LCG configuration will be considered to override the set included in the BSR configuration. However, if the LCH/LCG configuration does not include a BSR table set, the UE 104 may use the BSR table set from the BSR configuration.

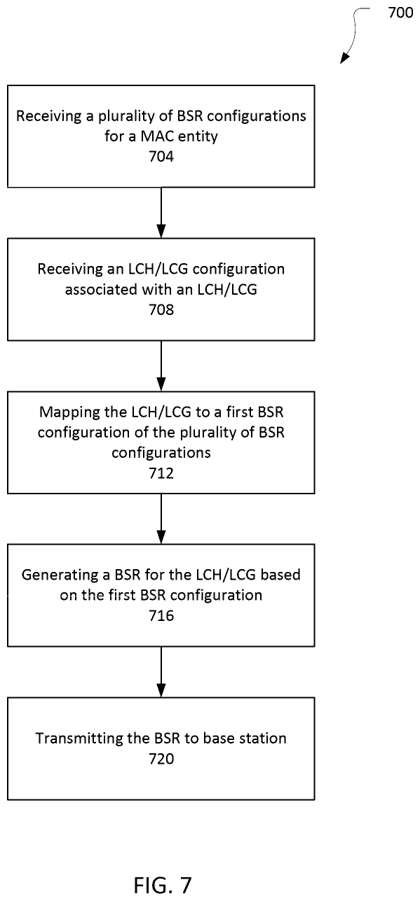

FIG. 7 illustrates an operation flow/algorithmic structure 700 for configuring and performing buffer status reporting in accordance with some embodiments. The operation flow/algorithmic structure 700 may be implemented by a UE such as, for example, UE 104 or 1000 or components therein, for example, processors 1004.

The operation flow/algorithmic structure 700 may include, at 704, receiving a plurality of BSR configurations for a MAC entity. The BSR configurations may be received from a base station via radio resource control (RRC) signaling. The plurality of BSR configurations may be received in one or more configuration messages. Individual BSR configurations may include one or more BSR-related parameters as described elsewhere herein.

The operation flow/algorithmic structure 700 may further include, at 708, receiving an LCH/LCG configuration associated with an LCH/LCG. The LCH/LCG configuration may be received from a base station via RRC signaling. The LCH/LCG configuration may be received along with, or separate from, the plurality of BSR configurations.

The operation flow/algorithmic structure 700 may further include, at 712, mapping the LCH/LCG to a first BSR configuration of the plurality of BSR configurations.

The mapping may be based on a BSR configuration ID included in the LCH/LCG configuration. In some embodiments, the LCH/LCG may be mapped to two or more BSR configurations including the first BSR configuration. The LCH/LCG may be mapped to the two or more BSR configurations at the same time, or may be conditionally mapped to a BSR configuration of the two or more BSR configurations. The conditional mapping may occur when a UE is configured to switch to different BSR configurations in the presence of predefined switching conditions. In some embodiments, a plurality of LCHs/LCGs may be mapped to the same BSR configuration.

In some embodiments, the LCH/LCG may not be explicitly associated with the first BSR configuration. For example, the LCH/LCG configuration may not include a BSR configuration ID of the first BSR configuration. In these embodiments, the UE may map the LCH/LCG to the first BSR configuration based on the first BSR configuration being designated a default BSR configuration.

The operation flow/algorithmic structure 700 may further include, at 716, generating a BSR for the LCH/LCG based on the first BSR configuration. For example, the BSR may be generated based on BSR-related parameters included in the first BSR configuration. In some embodiments, the BSR may be additionally generated based on one or more BSR-related parameters included in BSR configurations in addition to the first BSR configuration.

In some embodiments, the generating of the BSR may be based on detecting a triggering event indicated in the first BSR configuration.

The operation flow/algorithmic structure 700 may further include, at 720, transmitting the BSR to the base station. The transmission of the BSR to the base station may occur in the event a BSR is triggered and not canceled before transmission. In some instances, a triggered BSR may be canceled if BSR cancellation events of the first BSR configuration occur before the BSR is transmitted.

In some embodiments, the BSR may be included in a MAC BSR CE that is transmitted in a MAC PDU. In the event a plurality of MAC BSR CEs are triggered/generated, they may be selected for inclusion in the MAC PDU based on relatively priorities of associated BSR configurations. The relative priorities may be based on priority level indications in the BSR configurations; the BSR configuration identifiers (for example, a higher or lower identifier may be provided a higher priority); relative priority levels associated with the LCHs/LCGs; or BSR formats of the BSR configurations (for example, a BSR configuration with a BSR format having a delay reporting field may be prioritized over a BSR configuration with a BSR format that does not have a delay reporting field.

In some embodiments, the MAC PDU may include a plurality of BSR MAC CEs. Multiplexing two or more BSR MAC CEs into one MAC PDU may be unconditional (for example, permitted in all cases) or conditional. Examples of conditional multiplexing include multiplexing two or more BSR MAC CEs into the same MAC PDU when: at least one of the BSR MAC CEs is triggered by a specific BSR configuration; more than one (e.g., all) of the BSR MAC CEs are triggered by specific BSR configurations; or the BSR MAC CEs are triggered by different BSR configurations.

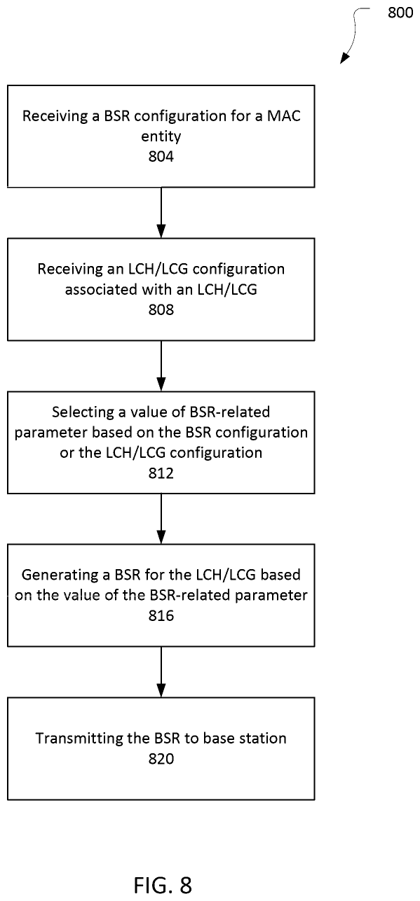

FIG. 8 illustrates an operation flow/algorithmic structure 800 for configuring and performing buffer status reporting in accordance with some embodiments. The operation flow/algorithmic structure 800 may be implemented by a UE such as, for example, UE 104 or 1000 or components therein, for example, processors 1004.

The operation flow/algorithmic structure 800 may include, at 804, receiving a BSR configuration for a MAC entity. The BSR configuration may be received from a base station via RRC signaling. The BSR configuration may include one or more BSR-related parameters as described elsewhere herein.

The operation flow/algorithmic structure 800 may further include, at 808, receiving an LCH/LCG configuration associated with an LCH/LCG. The LCH/LCG configuration may be received from a base station via RRC signaling. The LCH/LCG configuration may be received along with, or separate from, the BSR configuration.

The operation flow/algorithmic structure 800 may further include, at 812, selecting a value of a BSR-related parameter from a plurality of available values for the BSR-related parameter. The BSR-related parameter may include, but is not limited to, a buffer size table, a delay value table, a BSR format, a BSR trigger event, a BSR cancellation event, or a BSR MAC control element (CE) priority.

In some embodiments, the value of the BSR-related parameter may be selected from the BSR configuration. For example, the BSR configuration may include a plurality of parameter sets corresponding to a BSR-related parameter with each set having one or more values of the BSR-related parameters. The LCH/LCG configuration may then include a parameter set ID that the UE uses to identify a parameter set, and the value may be selected from the parameter set.

In some embodiments, the value of the BSR-related parameter may be selected from the LCH/LCG configuration. For example, the LCH/LCG configuration may include a set of one or more values of the BSR-related parameter and the UE may select the value from the set.

The operation flow/algorithmic structure 800 may further include, at 816, generating a BSR for the LCH/LCG based on the value of the BSR-related parameter. The BSR may be generated in a manner similar to that described elsewhere herein.

The operation flow/algorithmic structure 800 may further include, at 820, transmitting the BSR to the base station. The transmission of the BSR may be done in a manner similar to that described elsewhere herein.

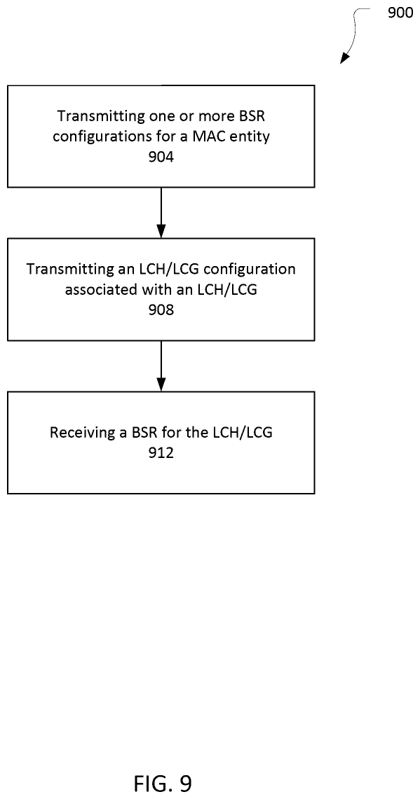

FIG. 9 illustrates an operation flow/algorithmic structure 900 for buffer status reporting in accordance with some embodiments. The operation flow/algorithmic structure 900 may be implemented by a base station such as, for example, base station 108 or 1100 or components therein, for example, processors 1104.

The operation flow/algorithmic structure 900 may include, at 904, transmitting one or more BSR configurations for a MAC entity. The BSR configuration may be transmitted to a UE via RRC signaling. Individual BSR configurations of the one or more BSR configurations may include one or more BSR-related parameters as described elsewhere herein.

The operation flow/algorithmic structure 900 may further include, at 908, transmitting an LCH/LCG configuration associated with an LCH/LCG. The LCH/LCG configuration may be transmitted to the UE via RRC signaling. The LCH/LCG configuration may be transmitted along with, or separate from, the one or more BSR configurations.

The one or more BSR configurations or the LCH/LCG configuration may configure a plurality of available values for a BSR-related parameter. The BSR-related parameter may include, but is not limited to, a buffer size table, a delay value table, a BSR format, a BSR trigger event, a BSR cancellation event, or a BSR MAC CE priority.

In some embodiments, the base station may configure a plurality of BSR configurations. A first BSR configuration may provide a first value of the plurality of available values for the BSR-related parameter and a second BSR configuration may provide a second value of the plurality of available values for the BSR-related parameter. The LCH/LCG configuration may be associated, either explicitly or implicitly, with the first or second BSR configuration. The UE may select a value from the first or second BSR configuration, whichever is associated with the LCH/LCG configuration, to generate a BSR for the LCH/LCG.

In some embodiments, the base station may provide one BSR configuration for the MAC entity. The BSR configuration may have a first set of one or more values of the plurality of available values and a second set of one or more values of the plurality of available values. The LCH/LCG configuration may be provided with an identifier associated with the first or second set of values, and the UE may select a value from the first or second set of values based on the identifier. The UE may use the value to generate a BSR for the LCH/LCG.

In some embodiments, the LCH/LCG configuration may include a set of one or more values of the plurality of available values. The UE may select a value from the set of one or more values for generating the BSR for the LCH/LCG.

The operation flow/algorithmic structure 900 may further include, at 912, receiving a BSR for the LCH/LCG. The BSR may be generated based on the value of the BSR-related parameter selected as described above. The BSR may be generated in a manner similar to that described elsewhere herein.

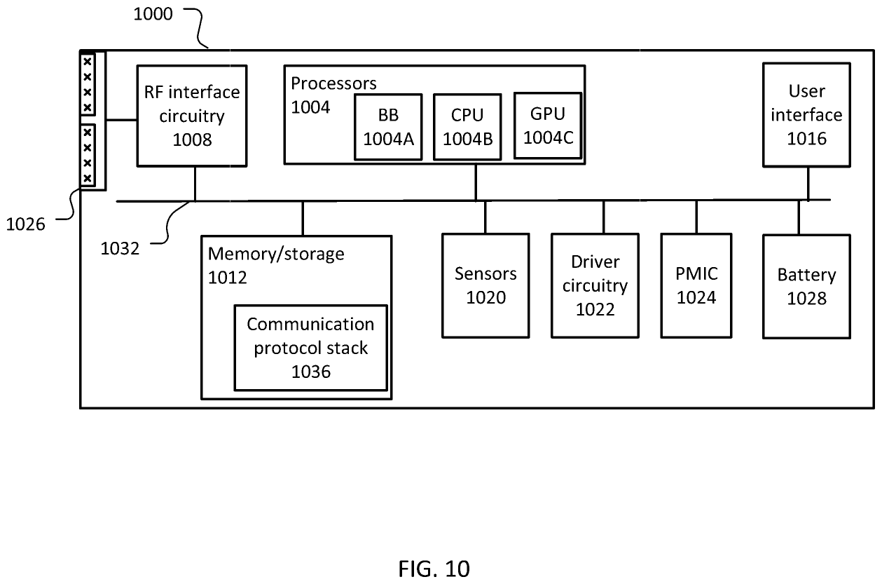

FIG. 10 illustrates a UE 1000 in accordance with some embodiments. The UE 1000 may be similar to and substantially interchangeable with UE 104 of FIG. 1.

The UE 1000 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform BSR-related operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations described herein.

The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1026.

In various embodiments, the RF interface circuitry 1008 may be configured to transmit/receive signals in a manner compatible with NR access technologies.

The antenna structure 1026 may include antenna elements to convert electrical signals into radio waves to travel through the air and to convert received radio waves into electrical signals. The antenna elements may be arranged into one or more antenna panels. The antenna structure 1026 may have antenna panels that are omnidirectional, directional, or a combination thereof to enable beamforming and multiple input, multiple output communications. The antenna structure 1026 may include microstrip antennas, printed antennas fabricated on the surface of one or more printed circuit boards, patch antennas, or phased array antennas. The antenna structure 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various I/O devices that may be present within, or connected to, the UE 1000. For example, the driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000 including DRX as discussed herein.

A battery 1028 may power the UE 1000, although in some examples the UE 1000 may be mounted deployed in a fixed location, and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

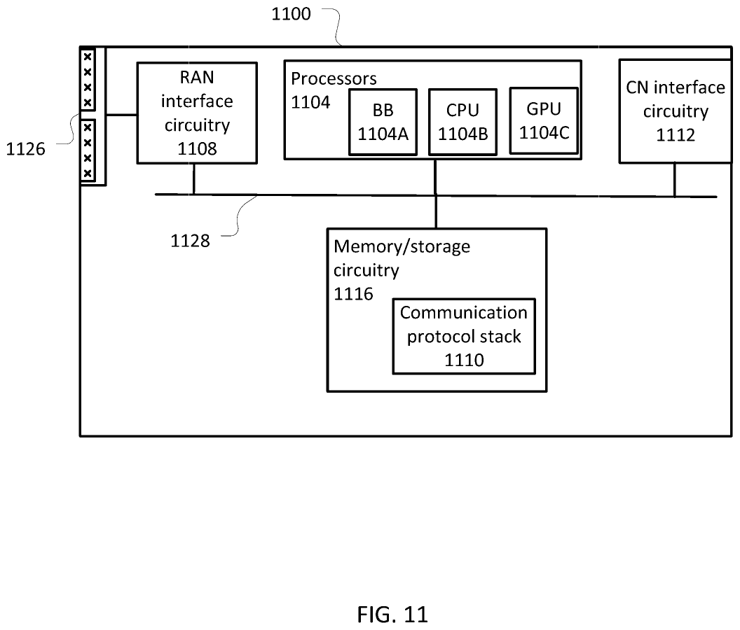

FIG. 11 illustrates a base station 1100 in accordance with some embodiments. The base station 1100 may be similar to and substantially interchangeable with base station 108, a device implementing one of the network hops 114, an IAB node, a network-controlled repeater, or a server in a core network or external data network.

The base station 1100 may include processors 1104, RF interface circuitry 1108 (if implemented as an access node), core network (CN) interface circuitry 1112, memory/storage circuitry 1116, and antenna structure 1126.

The components of the base station 1100 may be coupled with various other components over one or more interconnects 1128.

The processors 1104, RF interface circuitry 1108, memory/storage circuitry 1116 (including communication protocol stack 1110), antenna structure 1126, and interconnects 1128 may be similar to like-named elements shown and described with respect to FIG. 10.

The CN interface circuitry 1112 may provide connectivity to a core network, for example, a 5th Generation Core network (5GC) using a 5GC-compatible network interface protocol such as carrier Ethernet protocols, or some other suitable protocol.

Network connectivity may be provided to/from the base station 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

In some embodiments, the base station 1100 may be coupled with transmit receive points (TRPs) using the antenna structure 1126, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method to be implemented by a user equipment (UE), the method comprising: receiving a plurality of buffer status report (BSR) configurations for a media access control (MAC) entity; receiving a logical channel (LCH)/logical channel group (LCG) configuration associated with an LCH/LCG; mapping the LCH/LCG to a first BSR configuration of the plurality of BSR configurations; and generating a BSR for the LCH/LCG based on the first BSR configuration.

Example 2 includes a method of example 1 or some other example herein, wherein the first BSR configuration comprises: a BSR configuration identifier (ID), a buffer size table ID, a delay value table ID, a BSR format ID, a BSR trigger event ID, a BSR cancellation event ID, or a BSR MAC control element (CE) priority.

Example 3 includes the method of example 1 or some other example herein, wherein the first BSR configuration comprises a buffer format ID that is associated with a first BSR format, wherein the first BSR format corresponds to a first buffer-size granularity that is different from a second buffer-size granularity corresponding to a second BSR format.

Example 4 includes a method of example 1 or some other example herein, wherein the first BSR configuration comprises a BSR trigger event ID or a BSR cancellation event ID that is associated with an event that is based on: data for the LCH/LCG becoming available in a buffer; a volume of buffered data for the LCH/LCG compared to a predetermined threshold; a remaining time until a delivery deadline of buffered data for the LCH/LCG compared to a predetermined threshold; an occurrence of packet discarding in the LCH/LCG; or a volume of discarded data in the LCH/LCG compared to a predetermined threshold.

Example 5 includes a method of example 1 or some other example herein, wherein the LCH/LCG configuration includes a BSR configuration identifier (ID) associated with the first BSR configuration and said mapping the LCH/LCG to the first BSR configuration is based on the BSR configuration ID in the LCH/LCG configuration.

Example 6 includes a method of example 1 or some other example herein, wherein the first BSR configuration is a default configuration, the LCH/LCG configuration is not explicitly associated with the first BSR configuration, and said mapping the LCH/LCG to the first BSR configuration is based on the first BSR configuration being the default configuration.

Example 7 includes a method of example 1 or some other example herein, wherein the first BSR configuration is to indicate a triggering event and the method comprises: detecting the triggering event; and generating the BSR based on said detecting the triggering event.

Example 8 includes the method of example 1 or some other example herein, wherein the first BSR configuration is to indicate a cancellation event and the method comprises: detecting the cancellation event; and canceling transmission of the BSR based on said detecting the cancellation event.

Example 9 includes the method of example 1 or some other example herein, wherein the LCH/LCG is a first LCH/LCG, the BSR is in a first BSR MAC control element (CE), and the method further comprises: mapping a second LCH/LCG to the first BSR configuration; generating a second BSR MAC CE based on the first BSR configuration; generating a MAC protocol data unit (PDU) to include the first and second BSR MAC CEs; and transmitting the MAC CE.

Example 10 includes the method of example 1 or some other example herein, further comprising: mapping the LCH/LCG to a second BSR configuration of the plurality of BSR configurations.

Example 11 includes a method of example 10 or some other example herein, wherein the BSR is a first BSR and the method further comprises: detecting a switch event; mapping the LCH/LCG to the second BSR configuration based on said detecting the switch event; and generating a second BSR for the LCH/LCG based on the second BSR configuration.

Example 12 includes the method of example 1 or some other example herein, wherein the BSR is a first BSR and the method further comprises: generating a first BSR MAC control element (CE) to include the first BSR; generating a second BSR MAC CE to include a second BSR; and generating a MAC protocol data unit (PDU) to include the first BSR MAC CE or the second BSR MAC CE.

Example 13 includes a method of example 12 or some other example herein, wherein the LCH/LCG is a first LCH/LCG, the second BSR is generated based on a second BSR configuration associated with a second LCH/LCG, and the method further comprises: selecting, for inclusion in the MAC PDU, the first BSR MAC CE or the second BSR MAC CE based on relative priorities associated with the first BSR configuration and the second BSR configuration.

Example 14 includes the method of example 13 or some other example herein, further comprising: determining the relative priorities associated with the first BSR configuration and the second BSR configuration based: on a first priority level indication in the first BSR configuration and a second priority level indication in the second BSR configuration; a first BSR configuration identifier associated with the first BSR configuration and a second BSR configuration identifier associated with the second BSR configuration; a first priority level associated with the first LCH/LCG and a second priority level associated with the second LCH/LCG; or a first BSR format of the first BSR configuration having a delay reporting field and a second BSR format of the second BSR configuration not having a delay reporting field.

Example 15 includes the method of example 12 or some other example herein, wherein generating the MAC PDU comprises: generating the MAC PDU to include both the first BSR MAC CE and the second BSR MAC CE.

Example 16 includes a method to be implemented by a user equipment (UE), the method comprising: receiving a buffer status report (BSR) configuration for a media access control (MAC) entity; receiving a logical channel (LCH)/logical channel group (LCG) configuration associated with an LCH/LCG; selecting, from the BSR configuration or the LCH/LCG configuration, a value of a BSR-related parameter from a plurality of available values for the BSR-related parameter, wherein the BSR-related parameter is a buffer size table, a delay value table, a BSR format, a BSR trigger event, a BSR cancellation event, or a BSR MAC control element (CE) priority; and generating a BSR for the LCH/LCG based on the value.

Example 17 includes the method of example 16 or some other example herein, wherein: the BSR configuration comprises a first set of one or more values of the plurality of available values and a second set of one or more values of the plurality of available values; the LCH/LCG configuration includes an identifier associated with the first set of values; and the method further comprises: selecting the value from the first set of values based on the identifier.

Example 18 includes the method of example 16 or some other example herein, wherein the LCH/LCG configuration comprises a set of one or more values of the plurality of available values and the method further comprises: selecting the value from the set of one or more values.

Example 19 includes a method to be implemented by a base station, the method comprising: transmitting, to a user equipment (UE), one or more buffer status report (BSR) configurations for a media access control (MAC) entity; transmitting, to the UE, a logical channel (LCH)/logical channel group (LCG) configuration associated with an LCH/LCG, wherein the one or more BSR configurations or the LCH/LCG configuration is to configure one or more values for a BSR-related parameter, wherein the BSR-related parameter is a buffer size table, a delay value table, a BSR format, a BSR trigger event, a BSR cancellation event, or a BSR MAC control element (CE) priority; and receiving a BSR for the LCH/LCG generated based on a value of the BSR-related parameter selected from the one or more values.

Example 20 includes the method of example 19 or some other example herein, wherein the one or more BSR configurations includes a plurality of BSR configurations, wherein a first value of the plurality of available values for the BSR-related parameter is in a first BSR configuration of the plurality of BSR configurations and a second value of the plurality of available values for the BSR-related parameter is in a second BSR configuration of the plurality of BSR configurations.

Example 21 includes a method of example 19 or some other example herein, wherein: the one or more BSR configurations comprise a BSR configuration with a first set of one or more values of the plurality of available values and a second set of one or more values of the plurality of available values; the LCH/LCG configuration includes an identifier associated with the first set of values; and the value is selected from the first set of values based on the identifier.

Example 22 includes the method of example 19 or some other example herein, wherein the LCH/LCG configuration comprises a set of one or more values of the plurality of available values and the value is selected from the set of one or more values.

Another example may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Another example may include an apparatus comprising logic, modules, or circuitry to perform one or more elements of a method described in or related to any of examples 1-22, or any other method or process described herein.

Another example may include a method, technique, or process as described in or related to any of examples 1-22, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-22, or portions thereof.

Another example include a signal as described in or related to any of examples 1-22, or portions or parts thereof.

Another example may include a datagram, information element, packet, frame, segment, PDU, or message as described in or related to any of examples 1-22, or portions or parts thereof, or otherwise described in the present disclosure.

Another example may include a signal encoded with data as described in or related to any of examples 1-22, or portions or parts thereof, or otherwise described in the present disclosure.

Another example may include a signal encoded with a datagram, IE, packet, frame, segment, PDU, or message as described in or related to any of examples 1-22, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Another example may include a computer program comprising instructions, wherein execution of the program by a processing element is to cause the processing element to carry out the method, techniques, or process as described in or related to any of examples 1-22, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-22. (canceled)

23. One or more non-transitory, computer-readable media having instructions that, when executed, cause processing circuitry to:
receive a plurality of buffer status report (BSR) configurations for a media access control (MAC) entity;
receive a logical channel (LCH)/logical channel group (LCG) configuration associated with an LCH/LCG;
map the LCH/LCG to a first BSR configuration of the plurality of BSR configurations; and
generate a BSR for the LCH/LCG based on the first BSR configuration.

24. The one or more non-transitory, computer-readable media of claim 23, wherein the first BSR configuration comprises: a BSR configuration identifier (ID), a buffer size table ID, a delay value table ID, a BSR format ID, a BSR trigger event ID, a BSR cancellation event ID, or a BSR MAC control element (CE) priority.

25. The one or more non-transitory, computer-readable media of claim 23, wherein the first BSD configuration comprises a buffer format ID that is associated with a first BSR format, wherein the first BSR format corresponds to a first buffer-size granularity that is different from a second buffer-size granularity corresponding to a second BSR format.

26. The one or more non-transitory, computer-readable media of claim 23, wherein the first BSR configuration comprises a BSR trigger event ID or a BSR cancellation event ID that is associated with an event that is based on: data for the LCH/LCG becoming available in a buffer; a volume of buffered data for the LCH/LCG compared to a predetermined threshold; a remaining time until a delivery deadline of buffered data for the LCH/LCG compared to a predetermined threshold; an occurrence of packet discarding in the LCH/LCG; or a volume of discarded data in the LCH/LCG compared to a predetermined threshold.

27. The one or more non-transitory, computer-readable media of claim 23, wherein the LCH/LCG configuration includes a BSR configuration identifier (ID) associated with the first BSR configuration and the processing circuitry is to map the LCH/LCG to the first BSR configuration based on the BSR configuration ID in the LCH/LCG configuration.

28. The one or more non-transitory, computer-readable media of claim 23, wherein the first BSR configuration is a default configuration, the LCH/LCG configuration is not explicitly associated with the first BSR configuration, and the processing circuitry is to map the LCH/LCG to the first BSR configuration based on the first BSR configuration being the default configuration.

29. The one or more non-transitory, computer-readable media of claim 23, wherein the first BSR configuration is to indicate a triggering event and the instructions, when executed, further cause the processing circuitry to:
detect the triggering event; and
generate the BSR based on detection of the triggering event.

30. The one or more non-transitory, computer-readable media of claim 23, wherein the first BSR configuration is to indicate a cancellation event and the instructions, when executed, further cause the processing circuitry to:
detect the cancellation event; and
cancel transmission of the BSR based on said detecting the cancellation event.

31. The one or more non-transitory, computer-readable media of claim 23, wherein the LCH/LCG is a first LCH/LCG, the BSR is in a first BSR MAC control element (CE), and the instructions, when executed, further cause the processing circuitry to:
map a second LCH/LCG to the first BSR configuration;
generate a second BSR MAC CE based on the first BSR configuration;
generate a MAC protocol data unit (PDU) to include the first and second BSR MAC CEs; and
provide the MAC PDU for transmission.

32. The one or more non-transitory, computer-readable media of claim 23, wherein the instructions, when executed, further cause the processing circuitry to:
map the LCH/LCG to a second BSR configuration of the plurality of BSR configurations.

33. The one or more non-transitory, computer-readable media of claim 32, wherein the BSR is a first BSR and the instructions, when executed, further cause the processing circuitry to:
detect a switch event;
map the LCH/LCG to the second BSR configuration based on said detecting the switch event; and
generate a second BSR for the LCH/LCG based on the second BSR configuration.

34. The one or more non-transitory, computer-readable media of claim 23, wherein the BSR is a first BSR and the instructions, when executed, further cause the processing circuitry to:
generate a first BSR MAC control element (CE) to include the first BSR;
generate a second BSR MAC CE to include a second BSR; and
generate a MAC protocol data unit (PDU) to include the first BSR MAC CE or the second BSR MAC CE.

35. The one or more non-transitory, computer-readable media of claim 34, wherein the LCH/LCG is a first LCH/LCG, the second BSR is generated based on a second BSR configuration associated with a second LCH/LCG, and the instructions, when executed, further cause the processing circuitry to:
select, for inclusion in the MAC PDU, the first BSR MAC CE or the second BSR MAC CE based on relative priorities associated with the first BSR configuration and the second BSR configuration.

36. An apparatus comprising:
processing circuitry to:
receive a buffer status report (BSR) configuration for a media access control (MAC) entity;
receive a logical channel (LCH)/logical channel group (LCG) configuration associated with an LCH/LCG;
select, from the BSR configuration or the LCH/LCG configuration, a value of a BSR-related parameter from a plurality of available values for the BSR-related parameter, wherein the BSR-related parameter is a buffer size table, a delay value table, a BSR format, a BSR trigger event, a BSR cancellation event, or a BSR MAC control element (CE) priority; and
generate a BSR for the LCH/LCG based on the value; and
interface circuitry coupled with the processing circuitry, the interface circuitry to communicatively couple the processing circuitry with a component of a device.

37. The apparatus of claim 36, wherein: the BSR configuration comprises a first set of one or more values of the plurality of available values and a second set of one or more values of the plurality of available values; the LCH/LCG configuration includes an identifier associated with the first set of one or more values; and the processing circuitry is further to:
select the value from the first set of one or more values based on the identifier.

38. The apparatus of claim 36, wherein the LCH/LCG configuration comprises a set of one or more values of the plurality of available values and the processing circuitry is further to:
select the value from the set of one or more values.

39. A method comprising:
generating, for transmission to a user equipment (UE), one or more buffer status report (BSR) configurations for a media access control (MAC) entity;
generating, for transmission to the UE, a logical channel (LCH)/logical channel group (LCG) configuration associated with an LCH/LCG, wherein the one or more BSR configurations or the LCH/LCG configuration is to configure one or more values for a BSR-related parameter, wherein the BSR-related parameter is a buffer size table, a delay value table, a BSR format, a BSR trigger event, a BSR cancellation event, or a BSR MAC control element (CE) priority; and
processing a BSR for the LCH/LCG generated based on a value of the BSR-related parameter selected from the one or more values.

40. The method of claim 39, wherein the one or more BSR configurations includes a plurality of BSR configurations, wherein a first value of the one or more values for the BSR-related parameter is in a first BSR configuration of the plurality of BSR configurations and a second value of the one or more values for the BSR-related parameter is in a second BSR configuration of the plurality of BSR configurations.

41. The method of claim 39, wherein: the one or more BSR configurations comprise a BSR configuration with a first set of values of the one or more values and a second set of values of the one or more values; the LCH/LCG configuration includes an identifier associated with the first set of values; and the value is selected from the first set of values based on the identifier.

42. The method of claim 39, wherein the LCH/LCG configuration comprises a set of values of the one or more values and the value is selected from the set of values.
